(19) United States
(12) Patent Application Publication
(10) Pub. No.: US 2026/0175699 A1
(43) Pub. Date: Jun. 25, 2026

(54) APPARATUS FOR ASSISTING BRAKING OF ELECTRIC VEHICLE AND METHOD THEREOF

(71) Applicants: HYUNDAI MOTOR COMPANY, SEOUL (KR); KIA CORPORATION, SEOUL (KR)

(72) Inventor: Sang Hwa Do, Hwaseong-si (KR)

(73) Assignees: HYUNDAI MOTOR COMPANY, SEOUL (KR); KIA CORPORATION, SEOUL (KR)

(21) Appl. No.: 19/232,362

(22) Filed: Jun. 9, 2025

(30) Foreign Application Priority Data
Dec. 19, 2024 (KR) 10-2024-0191552

(51) Int. Cl. B60L 7/26; B60L 3/12; B60Q 9/00

(52) U.S. Cl. CPC B60L 7/26; B60L 3/12; B60Q 9/00; B60L 2240/54; B60L 2240/642

(57) ABSTRACT

Disclosed are an apparatus for assisting braking of an electric vehicle and a method thereof. The apparatus determines a motor braking amount based on the SOC of a battery when the SOC of the battery exceeds a reference SOC on a downhill road, and controls a motor control unit (MCU) to generate a motor reverse torque corresponding to the motor braking amount. Therefore, it is possible to assist the braking of a brake while preventing regenerative braking of the electric vehicle driving on a downhill road from being interrupted.

### CROSS REFERENCE TO RELATED APPLICATIONS

This application claims the benefit of priority to Korean Patent Application No. 10-2024-0191552, filed in the Korean Intellectual Property Office on Dec. 19, 2024, the entire contents of which are incorporated herein by reference.

### TECHNICAL FIELD

The present disclosure relates to a technology for assisting the braking of an electric vehicle driving down a hill.

### BACKGROUND

In general, electric vehicles may be classified into the following groups: pure electric vehicles that drive a motor using only electric energy stored in a rechargeable battery, solar cell vehicles that drive a motor using photovoltaics, fuel cell vehicles that drive a motor using a hydrogen fuel-based fuel cell, and hybrid vehicles that use two or more different types of power sources.

When such an electric vehicle performs braking control by the brake pedal while driving, the motor that assists the engine's output torque begins regenerative braking to recover deceleration energy and charge a battery. In this case, regenerative braking refers to a technology that generates electric energy by applying reverse torque to the motor using the energy generated during braking, and stores the generated electric energy in a battery.

In such regenerative braking, when the braking request of a user is detected, an electronic brake system (EBS) calculates the total braking execution amount, and a vehicle control unit (VCU) calculates the regenerative braking amount by considering the operating state of a motor and the current gear ratio. Thereafter, the EBS calculates the allowable regenerative braking amount based on the regenerative braking execution amount calculated by the VCU, and satisfies the braking excluding the allowable regenerative braking amount from the total braking amount through the hydraulic (friction) braking amount.

That is, the EBS distributes the total braking amount into the allowable regenerative braking amount and the hydraulic braking amount, and controls the hydraulic braking amount by receiving the regenerative braking execution amount fed back from the vehicle controller. Ultimately, the braking of an electric vehicle is performed through cooperative control of the EBS, which performs hydraulic braking, and the VCU, which performs regenerative braking.

Meanwhile, an electric vehicle driving on a downhill road stops regenerative braking to prevent the battery from being overcharged when the state of charge (SOC) of the battery reaches a full charge state (i.e. 100%). When regenerative braking is interrupted in such a manner, because the brake must bear the entire braking load of the electric vehicle, brake deterioration may be caused. Therefore, there is a need to provide a scheme capable of preventing the regenerative braking of an electric vehicle driving on a downhill road from being interrupted, while also assisting the braking of the brakes without additionally installing braking-related components of the electric vehicle.

The matters described in this background section are intended to promote an understanding of the background of the disclosure and may include matters that are not already known to those of ordinary skill in the art.

### SUMMARY

The present disclosure has been made to solve the above-mentioned problems occurring in the prior art while advantages achieved by the prior art are maintained intact.

One aspect of the present disclosure provides an apparatus for assisting braking of an electric vehicle and a method thereof capable of assisting the braking of a brake while preventing regenerative braking of the electric vehicle driving on a downhill road from being interrupted by determining a motor braking amount based on a state of charge (SOC) of a battery when the SOC of the battery exceeds a reference SOC on a downhill road, and controlling a motor control unit (MCU) to generate a motor reverse torque corresponding to the motor braking amount.

Another aspect of the present disclosure provides an apparatus for assisting braking of an electric vehicle and a method thereof capable of assisting the braking of a brake while preventing regenerative braking of the electric vehicle driving on a downhill road from being interrupted by obtaining forward downhill road information from a navigation system, predicting an SOC increase amount due to the regenerative braking on the downhill road, determining a reference SOC based on the predicted SOC increase amount, determining a motor braking amount based on a state of charge (SOC) of a battery when the SOC of the battery exceeds a reference SOC on a downhill road, and controlling a motor control unit (MCU) to generate a motor reverse torque corresponding to the motor braking amount.

Still another aspect of the present disclosure provides an apparatus for assisting braking of an electric vehicle and a method thereof capable of assisting the braking of a brake while preventing regenerative braking of the electric vehicle driving on a downhill road from being interrupted by determining a motor braking amount corresponding to a state of charge (SOC) of a battery based on a lookup table, in which different motor braking amounts are recorded for each SOC section of the battery, when the SOC of the battery exceeds a reference SOC on a downhill road, and controlling a motor control unit (MCU) to generate a motor reverse torque corresponding to the motor braking amount.

Still another aspect of the present disclosure provides an apparatus for assisting braking of an electric vehicle and a method thereof capable of assisting the braking of a brake while preventing regenerative braking of the electric vehicle driving on a downhill road from being interrupted by determining a motor braking amount based on a state of charge (SOC) of a battery when the SOC of the battery exceeds a reference SOC on a downhill road, controlling a motor control unit (MCU) to generate a motor reverse torque corresponding to the motor braking amount, and changing a direction of a rotating magnetic field of the motor to an opposite direction by the MCU.

Still another aspect of the present disclosure provides an apparatus for assisting braking of an electric vehicle and a method thereof capable of assisting the braking of a brake while preventing regenerative braking of the electric vehicle driving on a downhill road from being interrupted by determining a motor braking amount based on a state of charge (SOC) of a battery when the SOC of the battery exceeds a reference SOC on a downhill road, controlling a motor control unit (MCU) to generate a motor reverse torque corresponding to the motor braking amount, and changing a current phase angle of an inverter or changing an order of two phases among three phases (U, V, W) of the inverter by the MCU.

The technical problems to be solved by the present disclosure are not limited to the aforementioned problems, and any other technical problems not mentioned herein will be clearly understood from the following description by those skilled in the art to which the present disclosure pertains. Also, it may be easily understood that the objects and advantages of the present disclosure may be realized by the units and combinations thereof recited in the claims.

According to one aspect of the present disclosure, an apparatus for assisting braking of an electric vehicle includes a motor control unit (MCU) that controls an operation of a motor based on an inverter, and a controller that determines a motor braking amount based on a state of charge (SOC) of a battery when the SOC of the battery exceeds a reference SOC on a downhill road, and controls the MCU to generate a motor reverse torque corresponding to the motor braking amount.

According to an embodiment, the controller may obtain forward downhill road information from a navigation system provided in the electric vehicle, predict an SOC increase amount due to regenerative braking on the downhill road, and determine the reference SOC based on the predicted SOC increase amount.

According to an embodiment, the controller may determine a result of subtracting the predicted SOC increase amount from a fully charged state of the battery as the reference SOC.

According to an embodiment, the apparatus may further include storage that stores a lookup table in which different motor braking amounts are recorded for each SOC section of the battery.

According to an embodiment, the controller may determine the motor braking amount corresponding to the SOC of the battery based on the lookup table.

According to an embodiment, the controller may control the MCU to change a direction of a rotating magnetic field of the motor to an opposite direction in a process of generating the motor reverse torque corresponding to the motor braking amount.

According to an embodiment, the controller may control the MCU to change a current phase angle of the inverter in a process of generating the motor reverse torque corresponding to the motor braking amount.

According to an embodiment, the controller may control the MCU to change an order of two phases among three phases (U, V, W) of the inverter in a process of generating the motor reverse torque corresponding to the motor braking amount.

According to an embodiment, the controller may warn a user of overheating of a brake when a temperature of the motor exceeds a reference temperature.

According to another aspect of the present disclosure, a method of assisting braking of an electric vehicle includes determining, by a controller, a motor braking amount based on a state of charge (SOC) of a battery when the SOC of the battery exceeds a reference SOC on a downhill road, and controlling, by the controller, the MCU to generate a motor reverse torque corresponding to the motor braking amount.

According to an embodiment, the determining of the motor braking amount may include obtaining, by the controller, forward downhill road information from a navigation system provided in the electric vehicle, predicting, by the controller, an SOC increase amount due to regenerative braking on the downhill road, and determining, by the controller, the reference SOC based on the predicted SOC increase amount.

According to an embodiment, the determining of the reference SOC may include determining a result of subtracting the predicted SOC increase amount from a fully charged state of the battery as the reference SOC.

According to an embodiment, the method may further include storing, by storage, a lookup table in which different motor braking amounts are recorded for each SOC section of the battery.

According to an embodiment, the determining of the motor braking amount may include determining the motor braking amount corresponding to the SOC of the battery based on the lookup table.

According to an embodiment, the controlling of the MCU may include controlling the MCU to change a direction of a rotating magnetic field of a motor to an opposite direction.

According to an embodiment, the controlling of the MCU may include controlling the MCU to change a current phase angle of an inverter.

According to an embodiment, the controlling of the MCU may include controlling the MCU to change an order of two phases among three phases (U, V, W) of an inverter.

According to an embodiment, the controlling of the MCU may include warning a user of overheating of a brake when a temperature of a motor exceeds a reference temperature.

### BRIEF DESCRIPTION OF THE FIGURES

The above and other objects, features and advantages of the present disclosure will be more apparent from the following detailed description taken in conjunction with the accompanying drawings:

FIG. 1 is a block diagram illustrating an example of an electric vehicle to which an embodiment of the present disclosure is applied;

FIG. 2 is a diagram illustrating one example of a pop-up window displayed by a touch screen provided in an electric vehicle to which an embodiment of the present disclosure is applied;

FIG. 3 is a diagram illustrating another example of a pop-up window displayed by a touch screen provided in an electric vehicle to which an embodiment of the present disclosure is applied;

FIG. 4 is a block diagram illustrating the configuration of an apparatus for assisting braking of an electric vehicle according to an embodiment of the present disclosure;

FIG. 5 is a diagram illustrating an example of a process in which a controller provided in an apparatus for assisting braking of an electric vehicle according to an embodiment of the present disclosure determines a motor braking amount;

FIG. 6 is a flowchart illustrating a method of assisting braking of an electric vehicle according to an embodiment of the present disclosure;

FIG. 7 is a detailed flowchart illustrating a method of assisting braking of an electric vehicle according to an embodiment of the present disclosure; and

FIG. 8 is a block diagram illustrating a computing system for executing a method of assisting braking of an electric vehicle according to each embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is specified by the identical numeral even when they are displayed on other drawings. Further, in describing the embodiment of the present disclosure, a detailed description of the related known configuration or function will be omitted when it is determined that it interferes with the understanding of the embodiment of the present disclosure.

Terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

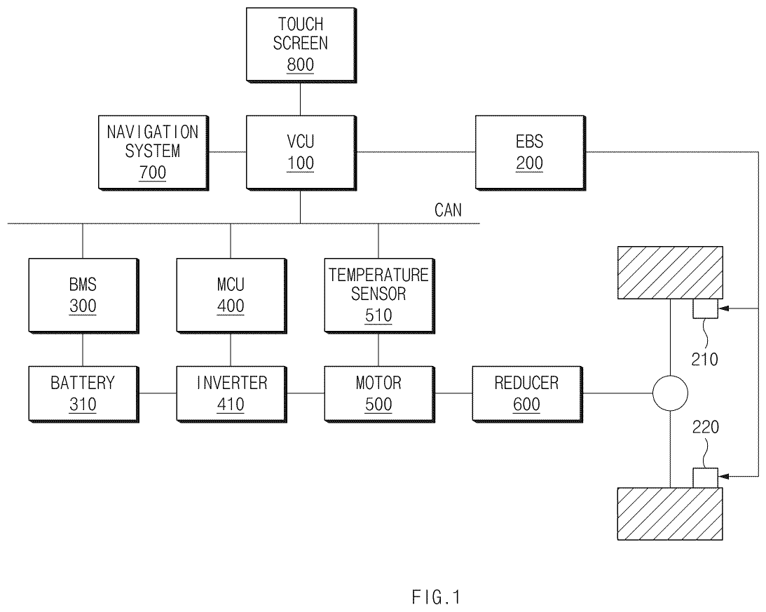

FIG. 1 is a block diagram illustrating an example of an electric vehicle to which an embodiment of the present disclosure is applied.

As illustrated in FIG. 1, an electric vehicle to which an embodiment of the present disclosure is applied may include a vehicle control unit (VCU) 100, an electronic brake system (EBS) 200, a right wheel brake 210, a left wheel brake 220, a battery management system (BMS) 300, a battery 310, a motor control unit (MCU) 400, an inverter 410, a motor 500, a temperature sensor 510, a reducer 600, a navigation system 700, and a touch screen 800.

First, the VCU 100, which is a top-level controller that controls the overall operation of the electric vehicle, may comprehensively control lower-level controllers connected to a network, and collect and analyze information from each lower-level controller to control the overall operation of the electric vehicle according to the request of a driver and the state of the vehicle. The VCU 100 may receive sensor signals from a motor speed sensor that detects the speed of a motor, a vehicle speed sensor that detects the speed of the vehicle, an accelerator pedal position sensor that detects the position value of an accelerator pedal, a brake pedal position sensor that detects the position value of a brake pedal, and the like.

The VCU 100 determines whether to perform regenerative braking based on the driving state of the electric vehicle and the braking request of the driver, determines the available torque of the battery 310 and the available torque of the motor 500 based on a signal from the BMS 300 when regenerative braking is required, calculates an allowable regenerative braking amount using the minimum torque among the available torque of the battery 310 and the available torque of the motor 500, and performs regenerative braking control based on the allowable regenerative braking amount. In this case, the VCU 100 may determine the available torque of the battery 310 based on the chargeable power and charging efficiency of the battery 310, and determine the available torque of the motor 500 based on a rated reduction factor set for a wheel torque and motor power.

When the braking request of the driver is detected, the EBS 200 determines the required braking torque from the pedal stroke and the hydraulic pressure of the master cylinder, and controls the hydraulic pressure supplied to the brake cylinder of each driving wheel based on the braking torque. That is, when the EBS 200 detects the driver's braking request, the VCU 100 may determine the regenerative braking amount, and the EBS 200 may perform deceleration control by controlling the hydraulic braking for the remaining braking amount after excluding the regenerative braking amount from the total braking amount.

The BMS 300 detects information about a voltage, a current, and a temperature of each cell within the operating area of the battery 310 to manage the charging state, and manages the SOC of the battery 310 under the control of VCU 100. The BMS 300 controls the voltage of the battery 310 to prevent the battery 310 from being over-discharged below the limit voltage or over-charged above the limit voltage.

The MCU 400 controls the driving and torque of the motor 500 according to the control of the VCU 100, and stores the electricity generated by the motor 500 during regenerative braking in the battery 310. The MCU 400 may include the inverter 410, and may use the inverter 410 to change the direction of the rotating magnetic field of the motor 500 to the opposite direction thereto. In this case, the MCU 400 may change the direction of the rotating magnetic field of the motor 500 to the opposite direction by changing the current phase angle of the inverter 410 or changing the order of two phases among the three phases (U, V, W).

The motor 500 may generate torque by operating on a three-phase AC voltage applied from the MCU 400. The motor 500 may operate as a generator during coasting or regenerative braking and supply the generated voltage to the battery 310. In this case, the temperature sensor 510 may measure the temperature of the motor 500.

The reducer 600, which is a type of transmission, may perform a function of efficiently driving wheels by reducing the rotation speed of the motor 500 and increasing the torque.

The navigation system 700 may store a precision map, receive location information of the electric vehicle from a global positioning system (GPS) satellite, map-match the electric vehicle to the precision map based on the location information, search for a route from the map-matched location to the destination, and display the searched route. In this case, the precision map may include various information about a driving road (e.g., a gradient angle, a curvature, or the like).

The touch screen 800, which is a module that provides a graphical interface with a user, may display various information to the user and receive information selected by the user.

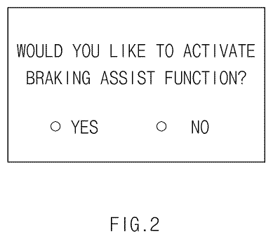

For example, the touch screen 800 may display a pop-up window as shown in FIG. 2 under the control of a controller 20. In this case, the touch screen 800 may receive information (yes or no) selected by the user.

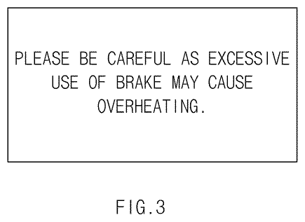

As another example, the touch screen 800 may display a warning pop-up window such as “Please be careful as excessive use of the brake may cause overheating.” as shown in FIG. 3, under the control of the controller 20.

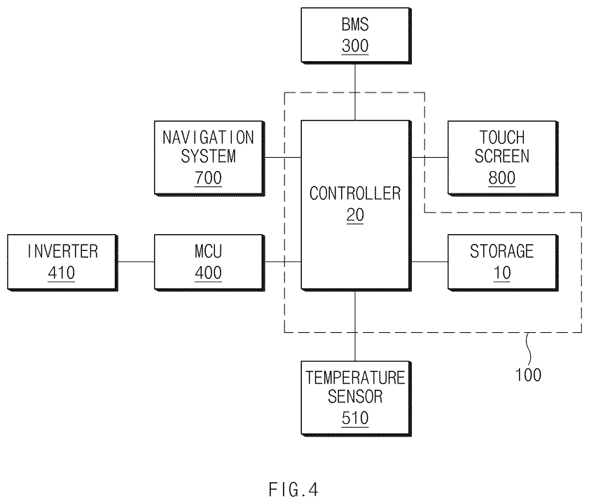

FIG. 4 is a diagram illustrating the configuration of an apparatus for assisting braking of an electric vehicle according to an embodiment of the present disclosure. Although an example performed by the VCU 100 is described, it may also be implemented as a separate configuration within the VCU 100.

As illustrated in FIG. 4, an apparatus 100 for assisting braking of an electric vehicle according to an embodiment of the present disclosure may include storage 10 and the controller 20. In this case, depending on a scheme of implementing an apparatus 100 for controlling braking of an electric vehicle according to an embodiment of the present disclosure, components may be combined with each other to be implemented as one, or some components may be omitted.

Regarding each component, first, the storage 10 may store various logic, algorithms and programs required in the process of determining a motor braking amount based on a state of charge (SOC) of the battery 310 when the SOC of the battery 310 exceeds a reference SOC on a downhill road, and controlling the MCU 400 to generate a motor reverse torque corresponding to the motor braking amount.

The storage 10 may store various logic, algorithms and programs required in the process of obtaining forward downhill road information from the navigation system 700, predicting an SOC increase amount due to the regenerative braking on the downhill road, determining a reference SOC based on the predicted SOC increase amount, determining a motor braking amount based on the SOC of the battery 310 when the SOC of the battery 310 exceeds a reference SOC on a downhill road, and controlling the MCU 400 to generate a motor reverse torque corresponding to the motor braking amount.

The storage 10 may store a lookup table in which different motor braking amounts are recorded for each SOC section of the battery 310.

The storage 10 may store various logic, algorithms and programs required in the process of determining a motor braking amount corresponding to an SOC section of the battery 310 based on a lookup table when the SOC of the battery 310 in an electric vehicle exceeds a reference SOC on a downhill road, and controlling the MCU 400 to generate a motor reverse torque corresponding to the motor braking amount.

The storage 10 may store various logic, algorithms and programs required in the process of determining a motor braking amount based on the SOC of the battery 310 when the SOC of the battery 310 exceeds a reference SOC on a downhill road, controlling the MCU 400 to generate a motor reverse torque corresponding to the motor braking amount, and changing a direction of a rotating magnetic field of the motor 500 to an opposite direction thereto.

The storage 10 may store various logic, algorithms and programs required in the process of determining a motor braking amount based on the SOC of the battery 310 when the SOC of the battery 310 exceeds a reference SOC on a downhill road, controlling the MCU 400 to generate a motor reverse torque corresponding to the motor braking amount, and changing a current phase angle of the inverter 410 or changing an order of two phases among three phases (U, V, W) of the inverter 410.

The storage 10 may store the weight of an electric vehicle.

The controller 20 may be electrically connected to each component and may perform overall control such that each component performs its function. The controller 20 may be implemented in the form of hardware or software, or may be implemented in a combination of hardware and software. Preferably, the controller 20 may be implemented as a microprocessor, but is not limited thereto.

The controller 20 may determine a motor braking amount based on the SOC of the battery 310 when the SOC of the battery 310 exceeds a reference SOC on a downhill road, and control the MCU 400 to generate a motor reverse torque corresponding to the motor braking amount.

The controller 20 may obtain forward downhill road information from the navigation system 700, predict an SOC increase amount due to the regenerative braking on the downhill road, and determine a reference SOC based on the predicted SOC increase amount. For example, the controller 20 may determine a result of subtracting the predicted SOC increase amount from the full charge state (i.e., 100%) of the battery 310 as the reference SOC.

The controller 20 may determine the motor braking amount corresponding to the SOC section of the battery 310 based on the lookup table stored in the storage 10.

The controller 20 may operate to control the MCU 400 to change a direction of a rotating magnetic field of the motor 500 to an opposite direction in the process of generating the motor reverse torque corresponding to the motor braking amount

The controller 20 may operate to control the MCU 400 to change a current phase angle of the inverter 410 or change an order of two phases among three phases (U, V, W) of the inverter 410 in the process of generating the motor reverse torque corresponding to the motor braking amount.

The controller 20 may obtain the temperature of the motor 500 from the temperature sensor 510, and when the temperature of the motor 500 exceeds a reference temperature, the output of the motor 500 may be derated so that the control of the motor reverse torque is limited, and as shown in FIG. 3, a warning pop-up may be displayed on the touch screen 800.

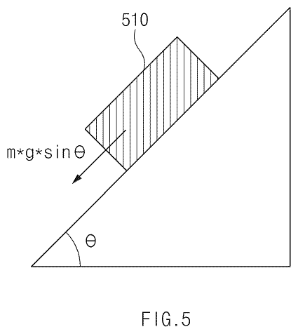

Hereinafter, the operation of the controller 20 will be described in detail with reference to FIG. 5.

FIG. 5 is a diagram illustrating an example of a process in which a controller provided in an apparatus for assisting braking of an electric vehicle according to an embodiment of the present disclosure determines a motor braking amount.

As illustrated in FIG. 5, a force (F) expressed as following Equation 1 is applied to an electric vehicle 510 driving down a hill.

$$F = m \times g \times sin θ \qquad [ Equation 1 ]$$

Where ‘m’ represents the weight of an electric vehicle, ‘g’ represents gravity, and ‘θ’ represents the gradient angle.

The controller 20 may determine the motor braking amount for each SOC section of the battery 310. For example, the controller 20 may divide the SOC section of the battery 310 into four sections.

In a first section, the motor braking amount (F₁) may be determined based on the following Equation 2, in a second section, the motor braking amount (F₂) may be determined based on the following Equation 3, in a third section, the motor braking amount (F₃) may be determined based on the following Equation 4, and in a fourth section, the motor braking amount (F₄) may be determined based on the following Equation 5.

In this case, the first section may be a section in which the SOC of the battery 310 is 92% or more and less than 94%, the second section may be a section in which the SOC of the battery 310 is 94% or more and less than 96%, the third section may be a section in which the SOC of the battery 310 is 96% or more and less than 98%, and the fourth section may be a section in which the SOC of the battery 310 is 98% or more and less than 100%.

$${F}_{1} = F \times 0.5 \qquad [ Equation 2 ]$$

$${F}_{2} = F \qquad [ Equation 3 ]$$

$${F}_{3} = F + ( m \times a ) \qquad [ Equation 4 ]$$

Where ‘m’ represents the weight of an electric vehicle and ‘a’ represents acceleration.

$${F}_{4} = F + ( m \times a ) + f \qquad [ Equation 5 ]$$

Where ‘f’ is a fixed value representing resistance (e.g., air resistance, rolling resistance, or the like).

Meanwhile, the MCU 400 may change the current phase angle of the inverter 410 or change the order of two phases among the three phases (U, V, W) based on the following Equation 6 to change the direction of the magnetic field of the motor 500 to the opposite direction thereto.

$$T = {P}_{n} \{ {Ψ}_{a} {i}_{a} cos β + \frac{1}{2} ( {L}_{q} - {L}_{d} ) {i}_{a}^{2} sin 2 β \} \qquad [ Equation 6 ]$$

Where ‘T’ represents the motor torque, Pₙ represents the number of motor poles, ψₐ represents the flux linkage due to the permanent magnet, iₐ represents the phase current, ‘β’ represents the current phase angle, L_{q} represents the torque axis (q-axis) inductance, and L_{d} represents the flux axis (d-axis) inductance.

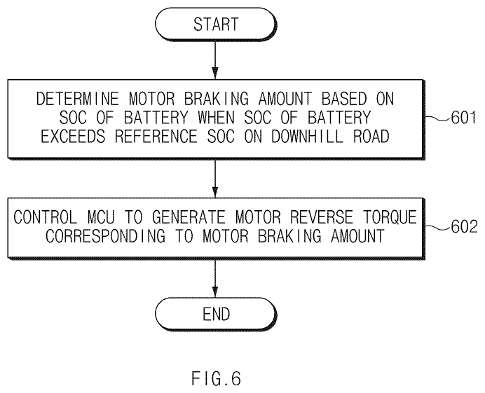

FIG. 6 is a flowchart illustrating a method of assisting braking of an electric vehicle according to an embodiment of the present disclosure.

First, in 601, the controller 20 determines the motor braking amount based on the SOC of the battery 310 when the SOC of the battery 310 exceeds a reference SOC on a downhill road.

Then, in 602, the controller 20 controls the MCU 400 to generate a motor reverse torque corresponding to the motor braking amount.

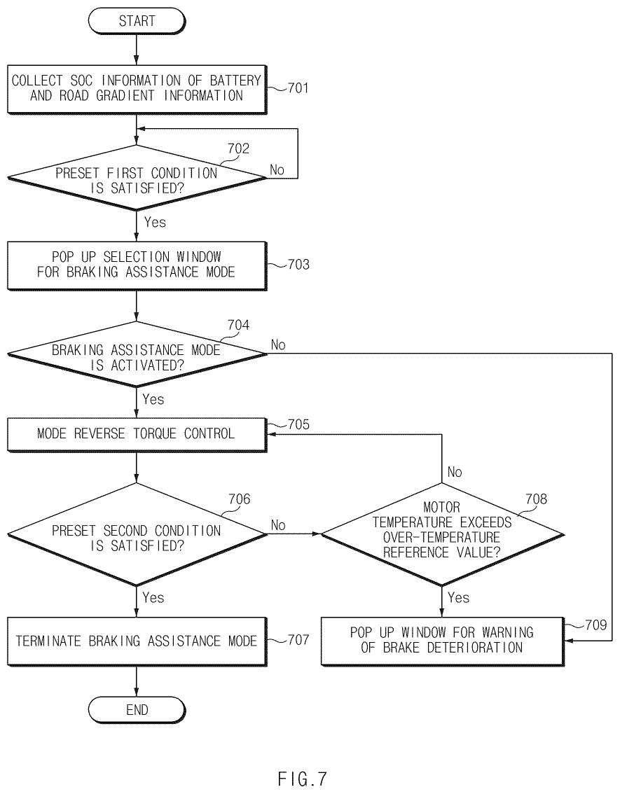

FIG. 7 is a detailed flowchart illustrating a method of assisting braking of an electric vehicle according to an embodiment of the present disclosure.

First, in 701, the controller 20 collects SOC information of the battery 310 from the BMS 300 and road gradient information from the navigation system 700 in real time.

Then, in 702, the controller 20 determines whether a preset first condition is satisfied. That is, the controller 20 determines whether the SOC value of the battery 310 exceeds a reference SOC value and also whether the gradient angle of the road is less than 0 (zero) (i.e., whether it is a downhill road).

When the preset first condition is satisfied, in 703, the controller 20 pops up a selection window for a braking assistance mode. In this case, a user may decide whether to activate the braking assistance mode.

When the user activates the braking assistance mode in 704, the controller 20 performs reverse torque control of the motor in 705. In this case, when the user does not activate the braking assistance mode, in 709, the controller 20 may pop up a window for warning of brake deterioration.

Then, in 706, the controller 20 determines whether a preset second condition is satisfied. That is, the controller 20 determines whether the SOC value of the battery 310 is lower than or equal to the reference SOC value, or whether the gradient angle of the road exceeds 0 (zero).

When the preset second condition is satisfied, in 707, the controller 20 terminates the braking assistance mode.

When the preset second condition is not satisfied, in 708, the controller 20 determines whether the temperature of the motor 500 exceeds an over-temperature reference value while maintaining the braking assistance mode.

When the temperature of the motor 500 does not exceed the over-temperature reference value, the process proceeds to operation “705”, and when the temperature of the motor 500 exceeds the over-temperature reference value, a window for warning of brake deterioration pops up in 709.

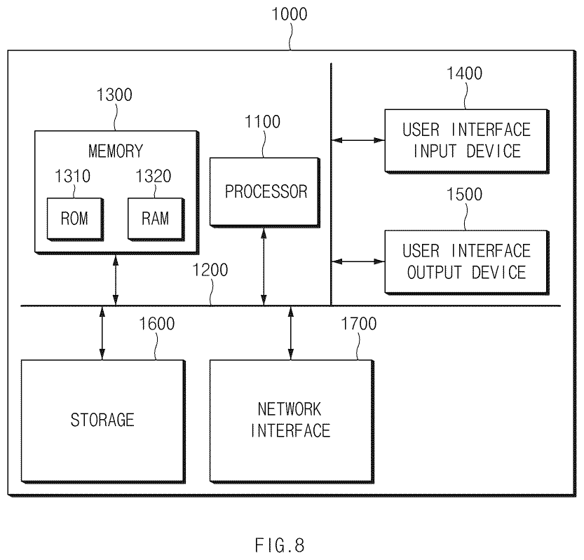

FIG. 8 is a block diagram illustrating a computing system for executing a method of assisting braking of an electric vehicle according to each embodiment of the present disclosure.

Referring to FIG. 8, as described above, the method of assisting braking of an electric vehicle according to an embodiment of the present disclosure may be implemented through a computing system 1000. The computing system 1000 may include at least one processor 1100, a memory 1300, a user interface input device 1400, a user interface output device 1500, storage 1600, and a network interface 1700 which are connected through a system bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) 1310 and a random access memory (RAM) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

According to the embodiments of the present disclosure, the motor braking amount may be determined based on the SOC of a battery when the SOC of the battery exceeds a reference SOC on a downhill road, and the MCU may be controlled to generate the motor reverse torque corresponding to the motor braking amount, so that it is possible to assist the braking of a brake while preventing regenerative braking of the electric vehicle driving on a downhill road from being interrupted.

1. An apparatus for assisting braking of an electric vehicle, the apparatus comprising:
a motor control unit (MCU) configured to control an operation of a motor based on an inverter; and
a controller configured to determine a motor braking amount based on a state of charge (SOC) of a battery when the SOC of the battery exceeds a reference SOC on a downhill road, and to control the MCU to generate a motor reverse torque corresponding to the motor braking amount.

2. The apparatus of claim 1, wherein the controller is configured to obtain forward downhill road information from a navigation system provided in the electric vehicle, to predict an SOC increase amount due to regenerative braking on the downhill road, and to determine the reference SOC based on the predicted SOC increase amount.

3. The apparatus of claim 2, wherein the controller is configured to determine a result of subtracting the predicted SOC increase amount from a fully charged state of the battery as the reference SOC.

4. The apparatus of claim 1, further comprising:
storage configured to store a lookup table in which different motor braking amounts are recorded for each SOC section of the battery.

5. The apparatus of claim 4, wherein the controller is configured to determine the motor braking amount corresponding to the SOC of the battery based on the lookup table.

6. The apparatus of claim 1, wherein the controller is configured to control the MCU to change a direction of a rotating magnetic field of the motor to an opposite direction in a process of generating the motor reverse torque corresponding to the motor braking amount.

7. The apparatus of claim 1, wherein the controller is configured to control the MCU to change a current phase angle of the inverter in a process of generating the motor reverse torque corresponding to the motor braking amount.

8. The apparatus of claim 1, wherein the controller is configured to control the MCU to change an order of two phases among three phases (U, V, W) of the inverter in a process of generating the motor reverse torque corresponding to the motor braking amount.

9. The apparatus of claim 1, wherein the controller is configured to warn a user of overheating of a brake when a temperature of the motor exceeds a reference temperature.

10. A method of assisting braking of an electric vehicle, the method comprising:
determining, by a controller, a motor braking amount based on a state of charge (SOC) of a battery when the SOC of the battery exceeds a reference SOC on a downhill road; and
controlling, by the controller, the MCU to generate a motor reverse torque corresponding to the motor braking amount.

11. The method of claim 10, wherein the determining of the motor braking amount includes:
obtaining, by the controller, forward downhill road information from a navigation system provided in the electric vehicle;
predicting, by the controller, an SOC increase amount due to regenerative braking on the downhill road; and
determining, by the controller, the reference SOC based on the predicted SOC increase amount.

12. The method of claim 11, wherein the determining of the reference SOC includes determining a result of subtracting the predicted SOC increase amount from a fully charged state of the battery as the reference SOC.

13. The method of claim 10, further comprising:
storing, by storage, a lookup table in which different motor braking amounts are recorded for each SOC section of the battery.

14. The method of claim 13, wherein the determining of the motor braking amount includes determining the motor braking amount corresponding to the SOC of the battery based on the lookup table.

15. The method of claim 10, wherein the controlling of the MCU includes controlling the MCU to change a direction of a rotating magnetic field of a motor to an opposite direction.

16. The method of claim 10, wherein the controlling of the MCU includes controlling the MCU to change a current phase angle of an inverter.

17. The method of claim 10, wherein the controlling of the MCU includes controlling the MCU to change an order of two phases among three phases (U, V, W) of an inverter.

18. The method of claim 10, wherein the controlling of the MCU includes warning a user of overheating of a brake when a temperature of a motor exceeds a reference temperature.

19. An electric vehicle comprising:
a motor;
an inverter;
a battery; and
a brake assist apparatus comprising:
a motor control unit (MCU) configured to control an operation of the motor based on the inverter; and
a controller configured to determine an amount of motor braking based on a state of charge (SOC) of the battery when the SOC of the battery exceeds a reference SOC on a downhill road, and to control the MCU to generate a motor reverse torque corresponding to the motor braking amount.
